(19) United States
(12) Patent Application Publication
(10) Pub. No.: US 2022/0153185 A1
(43) Pub. Date: May 19, 2022

(54) Hybrid Digital Micromirror Device (DMD) Headlight

(71) Applicant: Texas Instruments Incorporated, Dallas, TX (US)

(72) Inventors: Shashank Dabral, Allen, TX (US); Arthur Kreutzer, Mauern (DE); Jeffrey Matthew Kempf, Dallas, TX (US); Jaime Rene De La Cruz Vazquez, Carrollton, TX (US)

(21) Appl. No.: 17/238,204

(22) Filed: Apr. 23, 2021

Related U.S. Application Data
(60) Provisional application No. 63/114,018, filed on Nov. 16, 2020.

(51) Int. Cl. B60Q 1/14; G06T 7/521; H04N 5/225; H04N 5/04; H04N 5/235; B60Q 1/00; F21S 41/675

(52) U.S. Cl. CPC B60Q 1/1423; G06T 7/521; H04N 5/2256; H04N 5/04; H04N 5/2353; B60Q 2300/305; F21S 41/675; G06T 2207/30252; G06T 2207/10028; B60Q 2300/054; B60Q 2300/42; B60Q 1/0023

(57) ABSTRACT

A method is provided that includes projecting a hybrid headlight frame into a scene in front of a vehicle by a digital micromirror device (DMD) headlight, wherein the hybrid headlight frame includes a structured light pattern and a high beam headlight pattern, and capturing an image of the scene by a camera included in the vehicle while the structured light pattern is projected.

### CROSS-REFERENCE TO RELATED APPLICATIONS

This application claims benefit of U.S. Provisional Patent Application No. 63/114,018 filed Nov. 16, 2020, entitled “DMD Headlight Use Cases” which application is hereby incorporated herein by reference in its entirety.

### BACKGROUND

Recently, there has been a big push in the automotive lighting industry to improve both vehicle headlight functionality and driver visibility, which has led to the development of adaptive driving beam (ADB) headlights. An ADB system automatically controls the entire headlight, including high beams, enabling drivers to focus on the road and stop toggling high beams on or off based on lighting conditions and the presence of oncoming vehicles. More specifically, an ADB system enables a driver to drive with the high beams on at all times at night while automatically avoiding glare to drivers of oncoming vehicles. An ADB system may use cameras and other sensors to detect oncoming vehicles and continuously shape the high beams to avoid glare in the detected oncoming vehicle locations while continuing to fully illuminate other areas in front of the vehicle. Some such ADB systems are based on high-resolution headlight digital micromirror devices (DMDs). The use of DMD automotive technology in headlights can improve visibility over other technologies and also provide support for advanced driver assistance system (ADAS) functionality.

### SUMMARY

Embodiments of the present disclosure relate to using a digital micromirror device (DMD) headlight for structured light imaging. In one aspect, a method is provided that includes projecting a hybrid headlight frame into a scene in front of a vehicle by a digital micromirror device (DMD) headlight, wherein the hybrid headlight frame includes a structured light pattern and a high beam headlight pattern, and capturing an image of the scene by a camera included in the vehicle while the structured light pattern is projected.

In one aspect, a method is provided that includes generating a high beam headlight frame by a first processor included in a digital micromirror device (DMD) headlight control unit, wherein the high beam headlight frame includes a high beam headlight pattern, transmitting, by the first processor, the high beam headlight frame and a bit plane of a structured light pattern to a DMD controller included in the DMD headlight control unit, and generating, by the DMD controller, bit planes of a hybrid headlight frame, wherein the bit planes include the bit plane of the structured light pattern and bit planes of the high beam headlight pattern.

In one aspect, a vehicle is provided that includes a headlight including a digital micromirror device (DMD), a DMD headlight control unit coupled to the DMD, the DMD headlight control unit configured to cause the DMD to project a hybrid headlight frame, wherein the hybrid headlight frame includes a structured light pattern and a high beam headlight pattern, a camera, and an advanced driver assistance systems (ADAS) electronic control unit (ECU) coupled to the camera, the ADAS ECU configured to trigger the camera to capture an image of the structured light pattern.

### BRIEF DESCRIPTION OF THE DRAWINGS

FIG. 1 is a high level block diagram of an example advanced driver assistance system (ADAS) electronic control unit (ECU) and an example digital micromirror device (DMD) headlight control unit;

FIG. 2 illustrates examples of hybrid headlight frames;

FIG. 3 is an example illustrating the use of hybrid and high beam sequences;

FIG. 4 is an overview of precision time protocol (PTP) for clock synchronization;

FIG. 5 is an example illustrating a technique for camera/projection synchronization;

FIG. 6 is an example illustrating changing the projection time of a structured light pattern in hybrid headlight frames;

FIG. 7 is a flow diagram of a method for structured light imaging using a DMD headlight;

FIG. 8 illustrates an example vehicle configured for structured light imaging using a DMD headlight; and

FIG. 9 is a flow diagram of a method for structured light imaging using a DMD headlight.

### DETAILED DESCRIPTION

Specific embodiments of the disclosure are described herein in detail with reference to the accompanying figures. Like elements in the various figures are denoted by like reference numerals for consistency

Many advanced driver assistance systems (ADAS) applications rely on knowing the depth of objects in the scene around the vehicle in order to perform correctly. Structured light imaging is a well-known technique for estimating the three-dimensional (3D) depth of a scene and shape of objects in the scene. The principle behind structured light imaging is to project a known pattern into a scene and capture an image of the scene overlaid with the projected pattern. The depth is estimated based on the deformation of the pattern in the image, i.e., the projected pattern is displaced or altered when projected onto objects in the scene and this displacement can be used to estimate the depth of the objects.

Embodiments of the disclosure provide for coordination of an adaptive driving beam (ADB) headlight system based on high-resolution headlight digital micromirror devices (DMDs) with at least one camera in an ADAS system to perform structured light imaging in support of depth detection in the scene illuminated by the headlights. When structured light imaging is to be performed, the ADB headlight system causes a DMD to project a hybrid headlight frame into the scene in front of the vehicle. As is explained in more detail herein, the hybrid headlight frame includes a structured light pattern that is projected for a part of the overall frame projection time and a high beam headlight pattern that is projected for the remainder of the overall frame projection time. The ADAS system causes the camera to capture an image of the scene during the time the structured light pattern is projected. In general, the projection time of the structured light pattern is short enough that the pattern is not visible to the human eye and does not visibly interfere with function of the headlight.

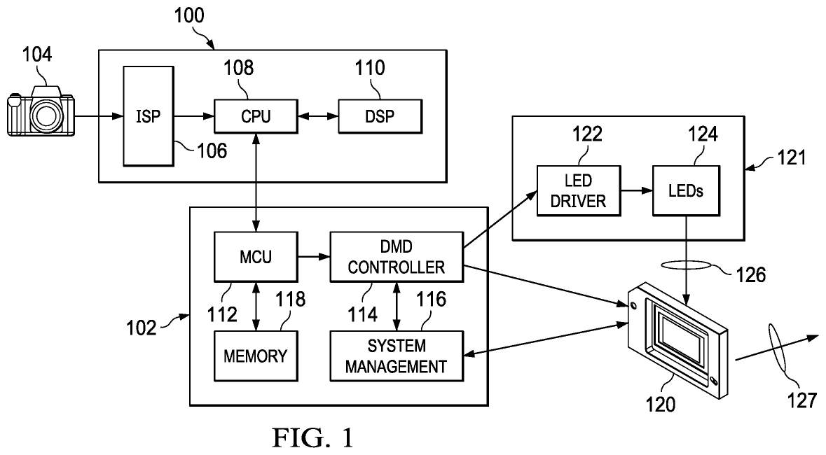

FIG. 1 is a high level block diagram of an example ADAS electronic control unit (ECU) 100 and an example DMD headlight control unit 102 configured to operate in coordination over a wireless connection to perform structured light imaging. The ADAS ECU 100, which may also be referred to as an ADAS domain controller or a sensor fusion controller, includes functionality to fuse sensor data from multiple sensors positioned on a vehicle, e.g., cameras, short- and long-range radar, lidar, ultrasound sensors, etc., for use by various ADAS applications, e.g., adaptive cruise control, lane tracking, obstacle detection, automatic braking, etc. The ADAS ECU 100 is coupled to a front facing camera 104 on the vehicle that may be used for both structured light imaging and capturing images of the scene in front of the vehicle for use by one or more ADAS applications. The ADAS ECU 100 includes an image signal processor (ISP) 106, a central processing unit (CPU) 108, and a digital signal processor (DSP) 110. The ISP 106 includes functionality to receive raw sensor data captured by the camera 104 and perform image processing on the raw sensor data to generate images suitable for use by ADAS applications e.g., decompanding, pixel correction, lens shading correction, spatial noise filtering, global and local brightness and contrast enhancement, de-mosaicing, and color conversion.

The DSP 110 includes functionality to process images captured by the camera 104 to detect objects in the scene, e.g., oncoming vehicles, and generate coordinates of bounding boxes indicating the locations of the objects. Further, the DSP 110 includes functionality to process structured light images captured by the camera 104 to perform depth detection in the scene. The CPU 108 includes functionality to communicate with the DMD headlight control unit 102 to provide the bounding box coordinates. The communication functionality may be, for example, a controller area network (CAN) or Ethernet protocol stack and the bounding box coordinates may be communicated to the DMD headlight control unit 102 in a headlight control command using the implemented protocol. Further, the CPU 108 includes functionality to communicate with the DMD headlight control unit and the camera 104 to coordinate capture of an image by the camera 104 when the DMD headlight control unit 102 causes the projection of a structured light pattern into the scene. The captured image may then be used by one or more ADAS applications to determine the depth of any objects in the scene.

The DMD headlight control unit 102 is coupled to a DMD 120 and an illumination source 121 for the DMD 120 in a headlight module (not shown). The DMD headlight control unit 102 includes a microcontroller unit (MCU) 112, a DMD controller 114, a system management component 116, and memory 118, e.g., a flash memory or other suitable memory technology. The DMD 120 may be, for example, a 1.3 megapixel DMD. The illumination source 121 includes a light-emitting diode (LED) driver 122 coupled to one or more white LEDs 124 and is configured to provide white light to illuminate the DMD 120 according to illumination control signals from the DMD controller 114. Illumination optics 126 are optically coupled between the DMD 120 and the LEDs 124 to prepare the light for illuminating the DMD 120. Projection optics 127 are optically coupled to the DMD 120 to receive light reflected by the DMD 120 and project the reflected light into the scene. Any suitable illumination optics and projection optics may be used.

The MCU 112 includes functionality to generate high beam headlight frames of a high beam headlight pattern for projection by the DMD 120. The MCU 112 further includes functionality to communicate with the CPU 108, e.g., to receive headlight commands containing bounding box coordinates, to perform clock synchronization as described herein, and to transmit camera trigger packets as described herein. The communication functionality may be, for example, a controller area network (CAN) or Ethernet protocol stack. If bounding box coordinates are received, the MCU 112 generates one or more high beam headlight frames in which the area or areas indicated by the bounding box coordinates are masked in the high beam headlight pattern to prevent glare. The MCU 112 also includes functionality to provide the generated high beam headlight frames to the DMD controller 114 to be projected by the DMD 120.

The MCU 112 also includes functionality to provide a structured light pattern to the DMD controller 114 to be used by the DMD controller 114 to cause the projection of a hybrid headlight frame by the DMD 120. The memory 118 stores the structured light pattern to be used in the hybrid headlight frames. The structured light pattern is a binary image with no gray shades and can be optimized to one bit per pixel and stored as a bit plane.

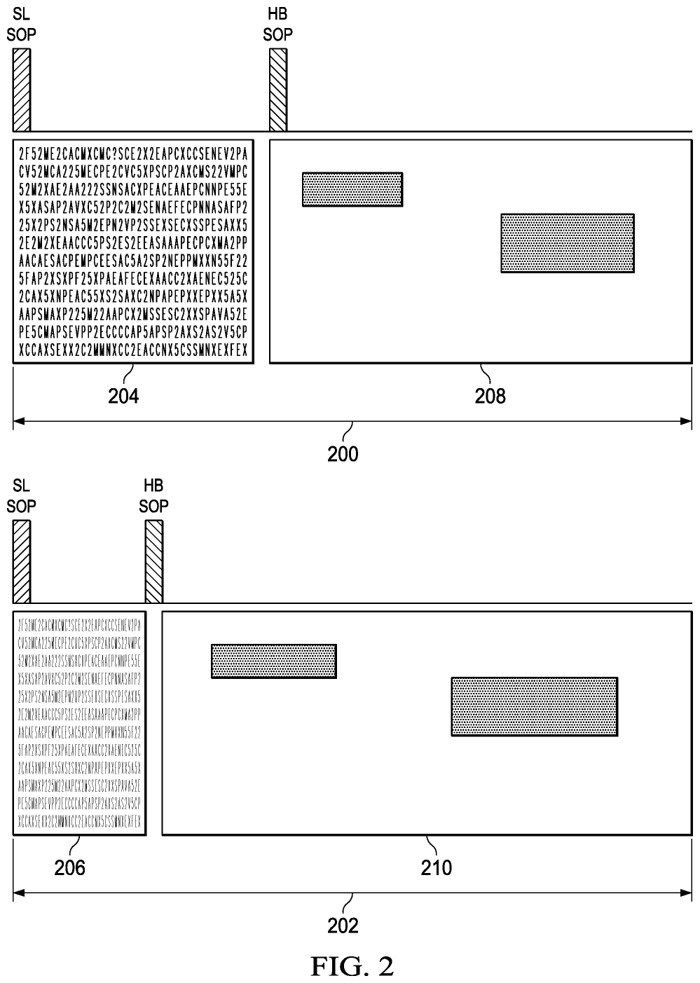

FIG. 2 illustrates examples of hybrid headlight frames. In these examples, each frame 200, 202 begins with a period of time in which the structured light (SL) pattern 204, 206 is projected and is followed by a period of time in which a high beam (HB) headlight pattern 208, 210 with masking is projected. As previously mentioned herein, areas of a high beam headlight frame corresponding to the locations of vehicles or other objects in the scene are masked, i.e., the pixels in these areas are turned off, to prevent glare. As is explained in more detail herein, the period of time in which the structured light pattern 204, 206 is projected is based on the amount of ambient light in the scene as the ambient light can affect the intensity of the structured light pattern in the captured image. For example, the higher the amount of ambient light, the longer the projection time of the structure light pattern in a frame projection time period and the shorter the projection time of the high beam headlight pattern in order to allow more camera exposure time to capture the structured light pattern. The time period for projection of the structured light pattern 204 in frame 200 is longer than the time period for projection of the structured light pattern 206 in frame 202 as there is more ambient light in the scene when frame 200 is to be projected than when frame 202 is to be projected.

Referring again to FIG. 1, the MCU 112 further includes functionality to communicate with the CPU 108 to coordinate capture of an image by the camera 104 when the structured light pattern of a hybrid headlight frame is projected into the scene. The MCU 112 may include, for example, a CPU core to manage communication with the CPU 108 according to, for example, CAN or Ethernet protocol, and a graphics processing unit (GPU) to generate the high beam headlight frames.

The system management component 116 includes functionality to control the power of the DMD 120 and provide monitoring and diagnostic information for the DMD 120 and the DMD controller 114.

The DMD controller 114 is a controller for the DMD 120 and the illumination source 121 and includes functionality to synchronize timing of the DMD 120 and the illumination source 121 for projection of high beam headlight frames and hybrid headlight frames. The DMD controller 114 further includes functionality to receive high beam headlight frames from the MCU 112 and format the frames for projection by the DMD 120. Because the DMD 120 is a binary device, the DMD controller 114 breaks a frame into individual patterns of ON or OFF data referred to as bit planes and transmits the bit planes to the DMD 120 in rapid succession.

A predetermined sequence defines how the DMD controller 114 converts an input frame for proper display by the DMD 120. A sequence includes information such as how many bit planes are to be projected, the amount of time each bit plane is to be projected, the order in which the bit planes are to be projected, and illumination control signals for synchronization of the illumination from the illumination source 121 with DMD positions. A more detailed description of an example DMD controller along with additional detail regarding the content of example sequences and control of an illumination source may be found, for example, in “DLP5531-Q1 Chipset Video Processing for Light Control Applications,” DLPA101, Texas Instruments, October 2018, which is hereby incorporated by reference herein in its entirety.

In this example, the DMD controller 114 is configured to process frames with 8-bit RGB pixels, i.e., there are separate input channels for R, G, and B pixels. For a single color headlight application, a single channel, e.g., the red (R) channel, is used to transmit high beam headlight frames from the MCU 112 to the DMD controller 114. Another channel, e.g., the blue (B) channel, is used to transmit the structured light pattern from the MCU 112 to the DMD controller 114. Whether the DMD controller 114 causes a high beam headlight frame or a hybrid headlight frame to be projected by the DMD 120 is controlled by selection of the sequence to be used. More specifically, memory in the DMD controller 114 may store a predetermined sequence for projecting a high beam headlight frame, i.e., a high beam sequence, and at least one predetermined sequence, i.e., a hybrid sequence, for projecting a hybrid headlight frame. The MCU 112 includes functionality to select which sequence the DMD controller should use and to communicate an identifier for the selected sequence to the DMD controller 114. The criteria for choosing which sequence to use is explained in more detail below.

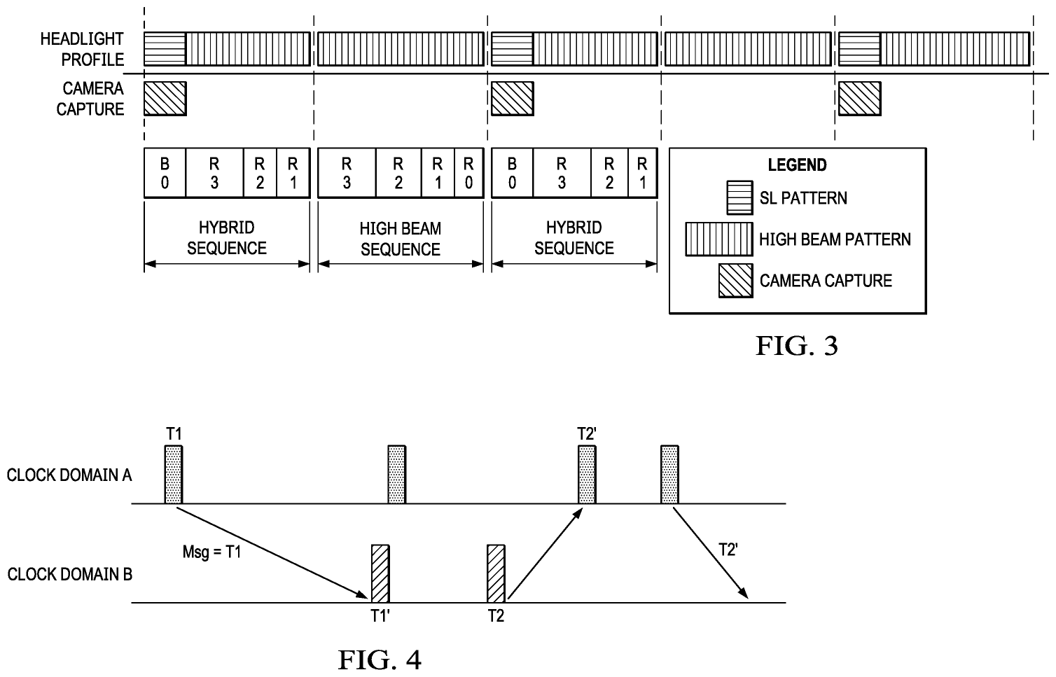

FIG. 3 is an example illustrating the use of hybrid and high beam sequences. For simplicity of explanation, a 4-bit pixel is assumed and a sequence is assumed to define only four bit planes, one for each pixel bit. The bit planes of the high beam pattern for the high beam headlight frame are referred to as R0, R1, R2, and R3 where R3 corresponds to the most significant bit, and the bit plane for the structured light pattern is referred to as BO.

The hybrid sequence includes BO and the three bit planes of the headlight frame corresponding to the three most significant bits of the pixels. When the hybrid sequence is selected, bit plane BO is projected during a frame projection time period for an amount of time defined in the hybrid sequence and the bit planes R3, R2, and R1 corresponding to the high beam headlight frame are projected in the remainder of the frame projection time period. When the high beam sequence is selected, the bit planes R3-R0 corresponding to the high beam headlight frame are projected. As illustrated by the headlight profile and the camera capture timelines, the camera 104 is triggered to capture a frame during the time the structured light pattern is projected.

The example of FIG. 3 shows alternating projection of a hybrid headlight frame and a high beam headlight frame for simplicity of explanation. As is explained in more detail herein, how often a hybrid headlight frame is projected is based on overall system requirements and the timing is controlled by the ADAS ECU 100. Further, although the example assumes 4-bit pixels and four bit planes, pixel sizes may be larger and the number of bit planes may be more than four.

Referring again to FIG. 1, close time synchronization between the ADAS ECU 100 and the DMD headlight control unit 102 helps ensure that the triggering of the camera 104 and the projection of the structured light pattern are synchronized, i.e., that the camera exposure time is aligned with the structured light pattern projection time. To support the camera/projection synchronization, the clocks of the ADAS ECU 100 and the MCU 112 are synchronized. This clock synchronization may be performed using a time synchronization protocol of the particular networking protocol used for communication between the ADAS ECU 100 and the MCU 112, e.g., CAN or Ethernet.

In some embodiments, the precision time protocol (PTP) of the Ethernet networking protocol is used for clock synchronization. The PTP protocol uses two variables to determine the relationship between two clocks, the propagation delay (d), which is the time taken for a message to propagate from one clock domain to the other, and the offset (o), which is the difference between the two clocks.

FIG. 4 is an overview of PTP clock synchronization. At time T1, clock domain A sends a message noting the time T1 to clock domain B. The message is received in clock domain B at time T1′. At this point, T1′−T1=d+o. At time T2, clock domain B sends a sync message to clock domain A, which is received by clock domain A at time T2″. Clock domain A then sends a message to clock domain B noting the time, T2′, that the sync message was received. At this point, T2′−T2=−o+d. Accordingly, o=½(T1′−T1−T2′+T2). Given the value of o, the timestamps between the clock domains can be synchronized.

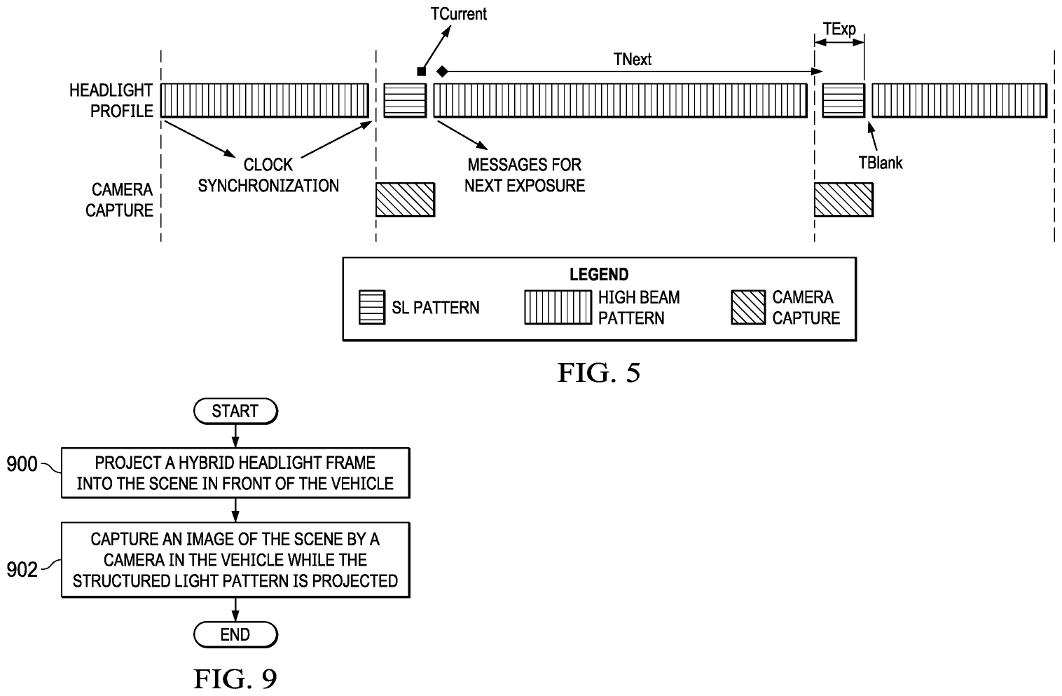

FIG. 5 is an example illustrating a technique for camera/projection synchronization between the ADAS ECU 100 and the MCU 112. In the illustrated technique, the clock offset (o) between the two system clocks is determining during the clock synchronization period. In this example, TCurrent is the current time in the MCU 112, TNext is the time delta until the next projection of the structured light pattern, TExp is the illumination or projection time for the next projection of the structured light pattern, and TBlank is the time period between the projection of the structured light pattern and the projection of the high beam pattern in the high beam headlight frame. As is explained below, the value of TExp may vary as the value depends on the particular hybrid sequence to be used to project the structured light pattern. The value of TNext is based on timing information from the ADAS ECU 100. A software program executing on a processor of the ADAS ECU 100, e.g., the DSP 110, determines how often the structured light pattern is to be projected based on criteria such as ADAS application requirements and communicates the timing information to the MCU 112. A software program executing on the MCU 112 uses the communicated timing information to set the value of TNext.

After each projection of the structured light pattern, the MCU 112 transmits a camera trigger packet to the ADAS ECU 100 that includes the values of TCurrent, TNext, and TExp. Given the offset (o), the software program executing on the ADAS ECU 100 can use the values of TCurrent and TNext to determine when to trigger the camera 104 to capture an image of the projected structure light pattern and the value of TExp to specify the camera exposure time. For example, the software program can set an exposure time for the camera 104 and trigger the image capture at the desired time via a camera driver (not shown) executing on ADAS ECU 100. The software program may allow some margin in the camera exposure time, e.g., approximately 100 ms, as compared to TExp to allow for error in the clock synchronization as there may be some drift over time. To accommodate this margin, the DMD headlight control unit 102 enforces a TBlank period of no illumination between the projection of the structured light pattern and the projection of the high beam pattern. Further, periodic clock synchronization may be performed to refine the value of the offset (o) to reduce the impact of any drift.

As was previously mentioned herein, the amount of time the structured light pattern is projected during a frame projection time period is based on the amount of ambient light in the scene. To allow for variations in the amount of ambient light, multiple hybrid sequences are defined in which each sequence has a different projection time for the structured light pattern. For example, if a range of projection times for the structured light pattern is 0.5 ms to 1.5 ms to accommodate expected changes in ambient light, hybrid sequences can be defined with projection times for the structured light pattern of 0.5 ms, 0.75 ms, 1 ms, 1.25 ms, and 1.5 ms.

A software program executing on a processor in the ADAS ECU 100, e.g., the DSP 110, monitors the amount of ambient light in images captured by the camera 104 and determines the projection time in the range of projection times to be used. A projection time indicator, e.g., the determined projection time or other value indicative of the desired projection time, is transmitted to the MCU 112. A software program executing on the MCU 112 then selects the appropriate hybrid sequence for the DMD controller 114 to use based on the projection time indicator. The ADAS ECU 100 software program may monitor the amount of ambient light by performing a histogram based analysis on the images using, e.g., the Y component of the images, to determine how bright or dark the scene is.

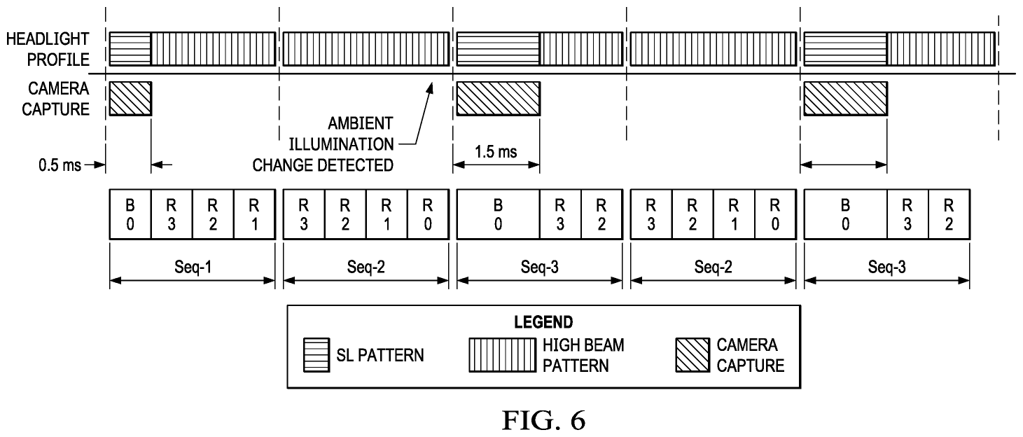

FIG. 6 is an example illustrating changing the projection time of the structured light pattern in hybrid headlight frames based on changes in ambient light in the scene. For simplicity of explanation, a 4-bit pixel is assumed and a sequence is assumed to define only four bit planes, one for each pixel bit. The bit planes of the high beam pattern for the headlight frame are referred to as R0, R1, R2, and R3 where R3 corresponds to the most significant bit, and the bit plane for the structured light pattern is referred to as BO. Projection according to three sequences is illustrated. Seq-1 is a hybrid sequence specifying a 0.5 ms projection time for the structured light pattern, Seq-2 is a high beam sequence, and Seq-2 is a hybrid sequence specifying a 1.5 ms projection time for the structured light pattern.

In this example, Seq-1 is used to project a hybrid headlight frame, followed by projection of a headlight frame using Seq-2. At some point during the projection of the headlight frame, the software program on ADAS ECU 100 determines that the amount of ambient light in the scene has changed sufficiently to warrant a change in the projection time of the structured light pattern, and communicates a new projection time, 1.5 ms, to the MCU 112. The software program on the MCU 112 then selects Seq-3 for projecting the next hybrid headlight frame. The MCU 112 continues to select Seq-3 for the hybrid headlight frame projection until a different projection time is received from the ADAS ECU 100. As illustrated by the headlight profile and the camera capture timelines, the camera 104 is triggered to capture an image during the time the structured light pattern is projected. The camera 104 may be used to capture images of the scene for other uses both before and after capturing the image during the projection of the structured light pattern.

The example of FIG. 6 shows alternating projection of a hybrid headlight frame and a high beam headlight frame for simplicity of explanation. As was previously explained, how often a hybrid headlight frame is projected is based on factors such as overall system requirements and the timing is controlled by the ADAS ECU 100. Further, although the example assumes 4-bit pixels and four bit planes, pixel sizes may be larger and the number of bit planes may be more than four.

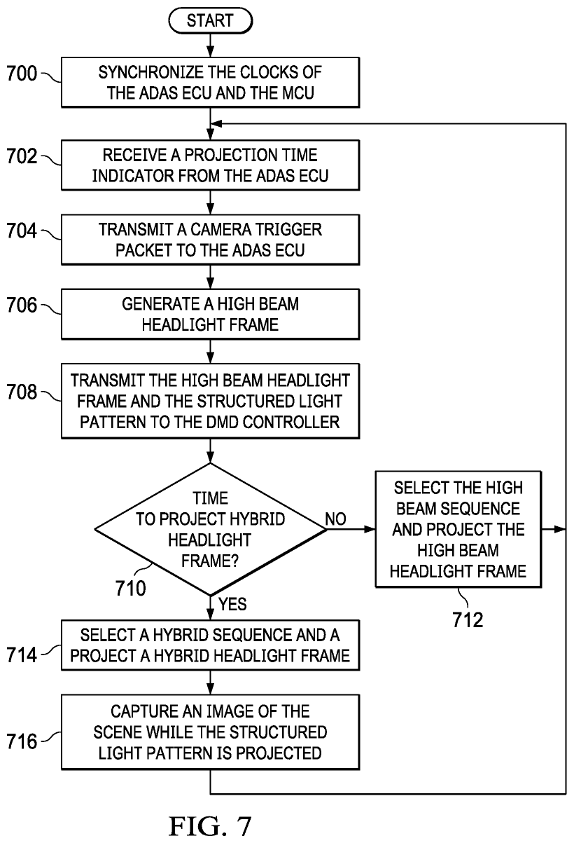

FIG. 7 is a flow diagram of a method for structured light imaging using a DMD headlight. The method is explained in reference to the ADAS ECU 100 and DMD headlight control unit 102 of FIG. 1. Initially, the clocks of the ADAS ECU 100 and the MCU 112 are synchronized 700, e.g., using the Ethernet PTP protocol or the CAN time synchronization protocol. For example, the PTP protocol uses two variables to determine the relationship between two clocks, the propagation delay (d), which is the time taken for a message to propagate from one clock domain to the other, and the offset (o), which is the difference between the two clocks. As is described in more detail herein in reference to FIG. 4, messages are exchanged between the two clock domains to determine the propagation delay (d) and the offset (o).

The MCU 112 receives 702 a projection time indicator for the structured light pattern from the ADAS ECU 100. As previously described herein, the projection time indicator is selected based on ambient light in the scene measured by a software program executing on a processor of the ADAS ECU 100. This step may not be performed in each iteration of the method as the ADAS ECU 100 may update the projection time indicator asynchronously when a change is needed due to an increase or decrease of ambient light in the scene.

The MCU 112 also transmits 704 a camera trigger packet to the ADAS ECU 100 indicating when the camera 104 should start capturing an image of the scene and for how long in order to capture an image containing the structured light pattern. This step is not performed in each iteration of the method; instead, the step is performed after a hybrid headlight frame is projected to inform the ADAS ECU 100 of the timing of the projection of the next hybrid headlight frame.

The MCU 112 generates a high beam headlight frame 706 for projection by the DMD 120. If bounding box coordinates corresponding to objects in the scene have been received from the ADAS ECU 100, the MCU 112 generates the high beam headlight frame with masked areas corresponding to the coordinates; otherwise, the high beam headlight frame is generated without any masked areas.

The MCU 112 transmits the high beam headlight frame and the structured light pattern stored in the memory 118 to the DMD controller 114 over two of the RGB channels as previously described herein. While both the headlight frame and the structured light pattern are provided, the sequence selected by the MCU 112 for the DMD controller 114 to use dictates whether or not the structured light pattern is used.

The MCU 112 then determines 710 whether or not it is time to project a hybrid headlight frame. If it is not time, the MCU 112 selects 712 the high beam sequence for use by the DMD controller 114, and the DMD controller 114 generates bit planes from the high beam headlight frame according to this sequence for projection by the DMD 120. The method then repeats beginning with step 702. If it is time, the MCU 112 selects 714 one of the hybrid sequences for use by the DMD controller 114 based on the last projection time indicator received from the ADAS ECU 100, and the DMD controller 114 generates bit planes of a hybrid headlight frame for projection by the DMD 120 according to the selected hybrid sequence. The camera 104 is also triggered by the ADAS ECU 100 in accordance with the camera trigger packet to capture 716 an image of the scene while the structured light portion of the hybrid headlight frame is projected. The method then repeats beginning with step 702.

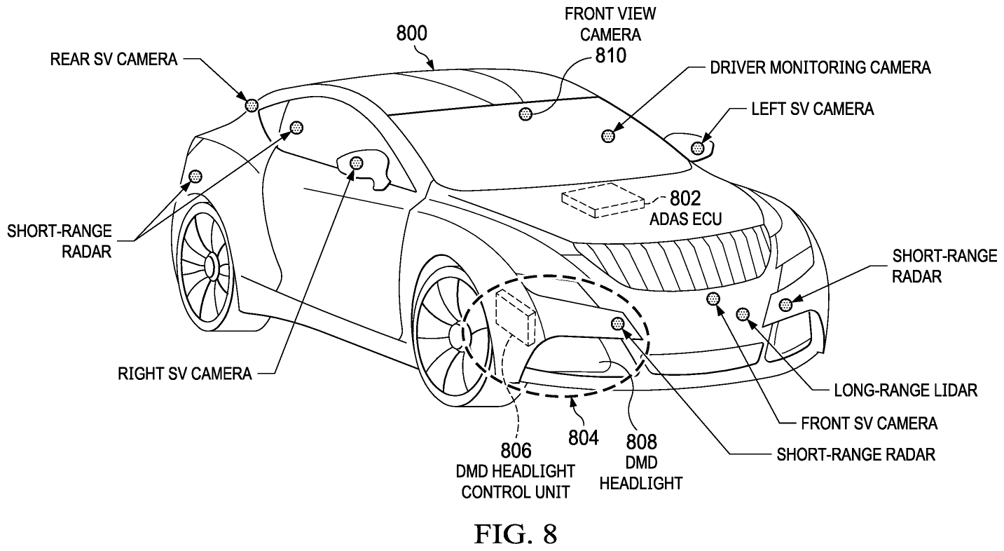

FIG. 8 illustrates an example vehicle 800 incorporating an ADAS electronic control unit (ECU) 802 coupled to various sensors, e.g., short range radar, long range lidar, and various surround view (SV) cameras, installed around the vehicle 800 and an ADB headlight system 804 based on DMD devices as exemplified by the DMD headlight control unit 806 and the DMD headlight 808. The ADAS ECU 802 includes functionality to perform ADAS applications, e.g., surround view, adaptive cruise control, collision warning, automatic braking, etc., using information received from the various sensors. Further, the ADAS ECU 802 includes functionality to detect oncoming vehicles from information received from one or more sensors and provide indicators of the locations of oncoming vehicles, e.g., object coordinates, to the ADB headlight system 804.

The ADB headlight system 804 includes functionality to automatically operate the headlights of the vehicle 800 in continuous high beam mode while using the location indicators received from the ADAS ECU 802 to mask out the high beam illumination in the scene in front of the vehicle at the indicated locations. Further, in accordance with embodiments described herein, the ADB headlight system 804 includes functionality to operate in coordination with the ADAS ECU 802 to perform structured light imaging in which the DMD headlight control unit 806 causes the DMD headlight 808 to project a structured light pattern into the scene in front of the vehicle 800 and the ADAS ECU 802 causes a camera, e.g., the front view camera 810, to capture an image when the pattern is projected.

FIG. 9 is a flow diagram of a method for structured light imaging using a DMD headlight in a vehicle. Initially, a hybrid headlight frame is projected 900 into the scene in front of the vehicle by the DMD headlight. Generation and projection of hybrid headlight frames including a structured light pattern and a high beam headlight pattern is previously described herein. An image of the scene is captured 902 by a camera in the vehicle while the structured light pattern in the hybrid headlight frame is projected. Synchronization of the image capture with the structured light pattern projection is previously described herein.

### OTHER EMBODIMENTS

While the disclosure has been described with respect to a limited number of embodiments, those skilled in the art, having benefit of this disclosure, will appreciate that other embodiments can be devised which do not depart from the scope disclosed herein.

For example, embodiments are described herein in which the structured light pattern of a hybrid headlight frame is projected before the high beam headlight pattern. In some embodiments, the structured light pattern can be projected at any time during the projection of the hybrid headlight frame.

In another example, embodiments are described herein in which a bit plane for the structured light pattern and the high beam headlight frame are provided to the DMD controller on separate channels and a sequence controls whether the full high beam headlight frame is projected or a hybrid headlight frame using the structured light bit frame is projected. In other embodiments, when a hybrid headlight frame is to be projected, the MCU generates the hybrid headlight frame and provides the frame to the DMD controller. For example, the MCU can generate a hybrid headlight frame in which each pixel includes seven bits of a high beam headlight pattern and one bit of a structured light pattern.

In another example, embodiments are described herein in which a high beam headlight frame may be generated with one or more masked areas. In some embodiments, a high beam headlight frame may also be generated with symbols, lane tracking markers, etc. if requested by an ADAS application.

In another example, embodiments are described herein in which the illumination for the DMD is provided by one or more LEDs coupled to an LED driver. In other embodiments, the illumination is provided by one or more lasers coupled to a laser driver.

It is therefore contemplated that the appended claims will cover any such modifications of the embodiments as fall within the true scope of the disclosure.

What is claimed is:

1. A method comprising:
projecting a hybrid headlight frame into a scene in front of a vehicle by a digital micromirror device (DMD) headlight, wherein the hybrid headlight frame comprises a structured light pattern and a high beam headlight pattern; and
capturing an image of the scene by a camera comprised in the vehicle while the structured light pattern is projected.

2. The method of claim 1, wherein projecting further comprises projecting the structured light pattern for a period of time determined based on ambient light in the scene.

3. The method of claim 2, wherein capturing further comprises using a camera exposure time corresponding to the period of time.

4. The method of claim 3, further comprising using a time synchronization protocol of a networking protocol to synchronize a clock of a first processor configured to trigger the camera to capture an image and a clock of a second processor configured to cause projection of the hybrid headlight frame by the DMD headlight.

5. The method of claim 4, further comprising:
transmitting a camera trigger packet from the second processor to the first processor after the projecting, wherein the camera trigger packet indicates a current time for the second processor, a time delta until a next structured light pattern is projected, and a projection time for the next structured light pattern in a next hybrid headlight frame;
projecting the next hybrid headlight frame into the scene in front of the vehicle by the DMD headlight, wherein the next structured light pattern is projected at the time delta and for the projection time; and
triggering the camera to capture an image of the scene based on the time delta and the projection time.

6. The method of claim 5, wherein the first processor is comprised in an advanced driver assistance systems (ADAS) electronic control unit (ECU) and the second processor is comprised in a DMD headlight control unit coupled to the ADAS ECU.

7. A method comprising:
generating a high beam headlight frame by a first processor comprised in a digital micromirror device (DMD) headlight control unit, wherein the high beam headlight frame comprises a high beam headlight pattern;
transmitting, by the first processor, the high beam headlight frame and a bit plane of a structured light pattern to a DMD controller comprised in the DMD headlight control unit; and
generating, by the DMD controller, bit planes of a hybrid headlight frame, wherein the bit planes comprise the bit plane of the structured light pattern and bit planes of the high beam headlight pattern.

8. The method of claim 7, further comprising:
selecting, by the first processor, a hybrid sequence for generating the bit planes of the hybrid headlight frame, wherein the hybrid sequence comprises a projection time for the bit plane of the structured light pattern and projection times for the bit planes of the high beam headlight pattern.

9. The method of claim 8, wherein selecting further comprises selecting from a plurality of hybrid sequences based on an amount of ambient light, wherein each hybrid sequence of the plurality of hybrid sequences comprises a different projection time for the bit plane of the structured light pattern.

10. The method of claim 7, further comprising:
transmitting, by the first processor, a camera trigger packet to a second processor coupled to a camera, wherein the camera trigger packet indicates a current time of the first processor, a time delta until the bit plane of the structured light pattern is projected, and a projection time for the structured light pattern.

11. The method of claim 10, further comprising:
projecting the bit plane of the structured light pattern by a DMD coupled to the DMD controller at the time delta and for the projection time; and
capturing, by the camera responsive to the camera trigger packet, an image when the structured light pattern is projected, wherein a camera exposure time based on the projection time is used.

12. The method of claim 10, further comprising synchronizing a clock of the first processor and a clock of the second processor using a time synchronization protocol of a networking protocol.

13. The method of claim 10, wherein the second processor is comprised in an advanced driver assistance systems (ADAS) electronic control unit (ECU).

14. A vehicle comprising:
a headlight comprising a digital micromirror device (DMD);
a DMD headlight control unit coupled to the DMD, the DMD headlight control unit configured to cause the DMD to project a hybrid headlight frame, wherein the hybrid headlight frame comprises a structured light pattern and a high beam headlight pattern;
a camera; and
an advanced driver assistance systems (ADAS) electronic control unit (ECU) coupled to the camera and to the DMD headlight control unit, the ADAS ECU configured to trigger the camera to capture an image of the structured light pattern.

15. The vehicle of claim 14, wherein the DMD headlight control unit is further configured to cause the DMD to project the structured light pattern for a period of time determined based on ambient light.

16. The vehicle of claim 14, wherein the ADAS ECU is further configured to trigger the camera to capture the image using a camera exposure time corresponding to a projection time of the structured light pattern.

17. The vehicle of claim 14, wherein the ADAS ECU and the DMD headlight control unit are further configured to synchronize a first clock of a first processor comprised in the ADAS ECU and a second clock of a second processor comprised in the DMD headlight control unit using a time synchronization protocol of a networking protocol.

18. The vehicle of claim 17, wherein the processor of the DMD headlight control unit is configured to transmit a camera trigger packet to the processor of the ADAS ECU, wherein the camera trigger packet indicates a current time for the processor of the DMD headlight control unit, a time delta until a next structured light pattern is projected, and a projection time for the next structured light pattern.
